(19) United States
(12) Patent Application Publication
(10) Pub. No.: US 2009/0058614 A1
(43) Pub. Date: Mar. 5, 2009

(54) ELECTRONIC IDENTIFICATION DEVICE OR TRANSPONDER FITTED WITH TWO ANTENNAE TUNED TO DIFFERENT FREQUENCIES

(75) Inventor: Thierry Roz, Les Hauts-Geneveys (CH)

Correspondence Address: GRIFFIN & SZIPL, PC, SUITE PH-1, 2300 NINTH STREET, SOUTH, ARLINGTON, VA, 22204, US

(73) Assignee: EM MICROELECTRONIC-MARIN S.A., Marin (CH)

(21) Appl. No.: 11/847,403

(22) Filed: Aug. 30, 2007

(51) Int. Cl. H04B 7/00

(52) U.S. Cl. 340/10.4

(57) ABSTRACT

The electronic identification device or transponder (2) comprises a trigger circuit (12) linked to receiving means (14) of an interrogation signal sent at a first frequency by a reader (4 or 6), this trigger circuit serving to supply power to the transponder. It comprises an electronic response circuit (18) linked to an antenna (20) operating at a second frequency higher than said first frequency. This device or transponder additionally comprises a second electronic response circuit (26) linked to the antenna (14) to emit a second response signal at approximately the first frequency. The device or transponder (2) is therefore configured to operate with a single-frequency reader (4) or with a double-frequency reader (6). The electronic logic circuit (10) is configured in order to control the transmission of first response signals at the first frequency and second response signals at the second, higher frequency.

### FIELD OF THE INVENTION

The present invention relates to an electronic identification device or transponder comprising two antennae respectively tuned to a first frequency and to a second frequency. In particular, the invention relates to such devices configured to receive activation power by means of an interrogation signal supplied by a reader at the first frequency and to respond at the second frequency, which is preferably higher than said first frequency. In the case of the present invention, the term “response” signifies the transmission of a coded signal in particular containing an identification code following the receipt of a command from a reader or simply following the receipt of an activation field at said first frequency supplied by a reader.

### BACKGROUND OF THE INVENTION

For identifying persons or animals in particular, it is known to use passive electronic identification devices or passive transponders that receive an interrogation signal from a reader. Interrogation signal is understood to mean either a coded command or simply the emission of an activation field for passive transponders present in a communication region belonging to the reader. From this interrogation signal the transponder draws the power necessary for its operation via a rectifier circuit that is well known to a person skilled in the art. In a first simple practical example, the transponder responds as soon as it has received sufficient activation power by modulating the interrogation signal by varying its quality. Thus, in this first embodiment, the transponders send a response signal by modulating the interrogation signal. Therefore, the reader must be configured in such a way as to be able to detect the modulation performed by the transponder on the signal that it emits itself. This detection is not easy given that the emitter antenna must be linked to means that allow the detection of a variation in impedance for the emitter antenna. Therefore, it is difficult to obtain such readers with a very high sensitivity.

In a second, more developed practical example, in particular when an anti-collision protocol controlled by the reader is provided, the transponders also have a demodulator that permits detection of at least one coded command in the interrogation signal.

Systems operating in accordance with the two above-mentioned practical examples have been sold and installed in large numbers, in particular for the identification of animals in animal farming. In general, these systems operate at low frequency, e.g. 125 kHz. The demand for transponders of this type remains significant, given the large number of identification systems installed for objects, animals or persons that operate at low frequency and in particular at this frequency of 125 kHz.

To respond to the problem of the first generation of the reader-transponder system mentioned above, another system generation has been proposed, in particular in patent documents EP 1 393 245 and U.S. Pat. No. 5,317,330. In these documents it is proposed that the transponders receive an interrogation signal or an activation signal at a first frequency, in particular at low frequency. This signal supplies the necessary power for operation of the transponder in accordance with the known operation of passive transponders. In contrast to the first system generation, the transponders respond by sending a response signal at a second frequency different from the first frequency, this second frequency preferably being higher than the first frequency. To achieve this, the passive transponder or passive electronic identification device generally comprises a second antenna, which emits a signal at the second frequency using the power received by a first antenna tuned to said first frequency.

A system according to the new generation has several advantages. By moving the activation or communication frequency away from the reader in the direction of the transponder and the response frequency from this transponder in the direction of the reader, it is possible to obtain higher sensitivity in reception by means of a relatively uncomplicated filtering operation. This additionally enables the communication distance to be increased, and this can be further increased by increasing the emission power of the reader. In fact, firstly, the emitter antenna of the reader no longer serves to receive and decode response signals. Thus, the emission level has virtually no adverse effect on the sensitivity to receipt of response signals at the different second frequency. The transmission of activation power at relatively low frequency is then advantageous since the attenuation as a function of distance is higher at low frequency. This therefore allows provision of a relatively high emission power for a reference power measured at ten metres from the reader, as described in wireless design approval standards.

Moreover, the transmission of responses from transponders at a second, higher frequency lying, for example, between 1 and 50 MHz, allows a very quick data transfer. This is important for the efficiency of the anti-collision protocol with a large number of transponders present in the interrogation field of the reader. Finally, a response signal supplied by the transponder at a higher frequency increases the communication distance between the transponder and the reader for a given emission power. This last fact is important, because the transponder has a relatively low emission power.

Thus, the new generation of identification system mentioned above in particular allows the identification of animals in groups when passing through a gate or when entering/leaving a means of transport for these animals. However, although the new generation is operational and has been proposed for some time on the market, it has not been able to make its mark, since several producers or distributors are equipped with the previous system operating at one low frequency. When a producer or distributor is equipped with the new generation, he is no longer able to use his system operating according to the previous generation. Moreover, it is not compatible with transponders that are still linked to the previous system and used in the animal production chain. Therefore, this situation poses a problem, for which the present invention proposes to provide an economical solution.

### SUMMARY OF THE INVENTION

The invention relates to an electronic identification device or transponder comprising:
a trigger circuit of this transponder linked to receiving means of an interrogation signal sent at a first frequency by a reader, this trigger circuit being configured to convert said received interrogation signal into electric power supply of the identification device or transponder;
first electronic response means linked to means for emitting a first response signal at a second frequency higher than said first frequency.

This device or transponder is characterised in that it additionally comprises second electronic response means linked to means for emitting a second response signal modulating said interrogation signal at said first frequency.

The electronic identification device according to the invention has the major advantage of being able to operate equally well both with readers of the previous generation and with readers of the new generation that operate at two different frequencies, as described in the introductory section of the present description of the invention. The identification device according to the invention receives an interrogation signal at a first frequency to activate this device and supply it with the necessary power for its operation. Then, it comprises first response means linked to means for emitting a response signal at a second frequency higher than the first frequency in accordance with the features of the new system generation. Moreover, to remain compatible with the previous single-frequency system generation, the device according to the invention is equipped with second electronic response means linked to means for emitting a response signal on a carrier wave of the first frequency, this carrier wave being supplied by the reader. In the following text the term response signal at the first frequency will be used to characterise this response signal modulating the activation signal.

According to various exemplary embodiments, the response signal at the first frequency and the response signal at the second frequency can be sent simultaneously or one following the other. They can also be sent alternately. Moreover, each of these two response signals can be sent in accordance with an anti-collision protocol. In a preferred exemplary embodiment it is possible to provide a single anti-collision protocol controlling the transmission of the two response signals. Numerous possibilities are available to the skilled person to control the transmission of response signals at the first frequency and at the second frequency.

According to more developed exemplary embodiments, the identification device according to the invention also comprises demodulation means for the interrogation signal received at the first frequency to receive either commands or data to be recorded. In another exemplary embodiment it is provided that commands or data are supplied by the reader at the second, higher frequency so that the transponder can receive commands or data only by operating with a reader of the new generation, i.e. operating at two different frequencies and equipped with two antennae.

### BRIEF DESCRIPTION OF THE DRAWINGS

The present invention shall be described below in more detail with reference to the drawings that are given by way of example without any restriction.

FIG. 1 schematically shows a first exemplary embodiment of the invention;

FIG. 2 shows an example of an anti-collision protocol for the two response signals sent by each transponder;

FIG. 3 schematically shows a second exemplary embodiment of the invention;

FIG. 4 schematically shows a third exemplary embodiment of the invention; and

FIG. 5 shows a more detailed electronic diagram of a transponder according to a fourth exemplary embodiment.

### DETAILED DESCRIPTION OF THE ILLUSTRATIVE EMBODIMENTS

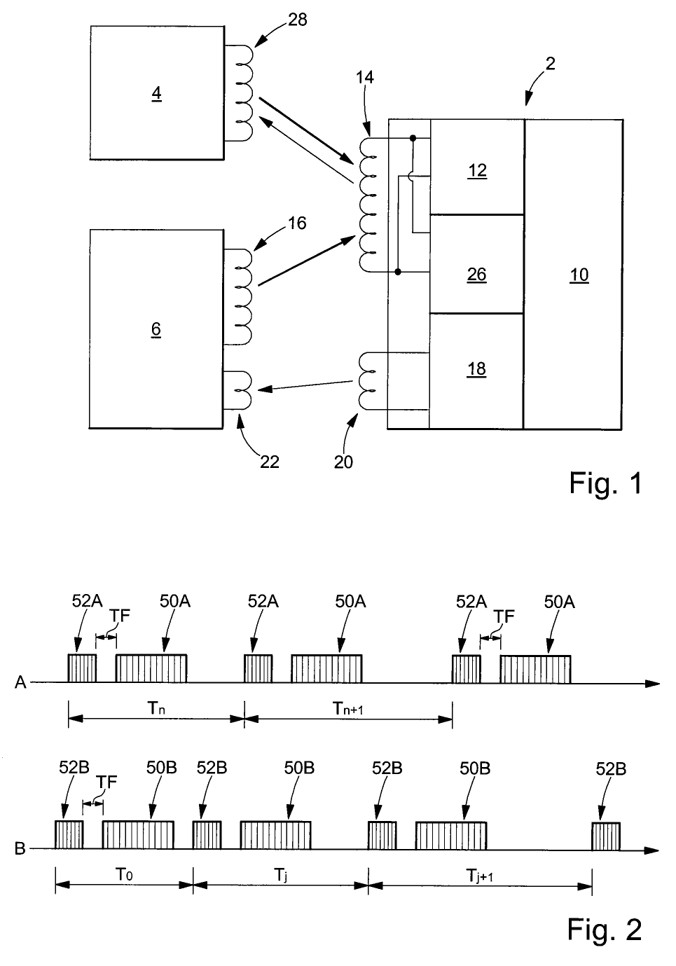

FIG. 1 shows a first exemplary embodiment of an identification system for objects, animals or persons according to the invention. More specifically, FIG. 1 schematically shows an electronic identification device 2 or transponder that is configured to be compatible with a first reader 4 operating at a single frequency as well as with a second reader 6 operating at two different frequencies. As outlined above, reader 4 forms part of an identification system of a first generation, while reader 6 belongs to another identification system of a second, more recent generation. The device 2, like any device configured to operate with the double-frequency reader 6, comprises an electronic logic circuit 10 and a trigger circuit 12 of this transponder 2 linked to receiving means 14 for an interrogation signal sent at a first frequency, in particular 125 kHz, by reader 6 via the antenna 16. The receiving means 14 comprise a first antenna tuned to said first frequency. The trigger circuit 12 is configured to convert the interrogation signal received by antenna 14 into electric power supply for the transponder 2. Then, this transponder has first electronic response means 18 linked to means 20 for emitting a first response signal emitted at a second frequency higher than the first frequency. The emission means 20 are formed by an antenna tuned to said second frequency. The transponder 2 is configured such that the first response signal emitted is received by the antenna 22 of reader 6, this antenna 22 also being tuned to the second frequency. Reader 6 comprises means to decode the response signal received.

According to the invention, to enable the transponder 2 to also be operational with reader 4 of the first identification system generation, it additionally comprises second electronic response means 26 linked to means 14 for emitting a second response signal at approximately said first frequency. The transponder 2 is configured such that this second response signal can be received by the antenna 28 of reader 4, this reader comprising means to decode the second response signal. Because of this configuration, the transponder 2 is able to communicate with the first reader 4 in a system according to the first generation as well as with reader 6 in a system according to the second generation. Therefore, the transponder 2 is polyvalent and is designed so as not to be dedicated to a single identification system.

The first frequency is equal to 125 kHz, for example, while the second frequency is equal to about 6.8 MHz or 13.56 MHz, for example.

In the figures the arrows in bold lines represent an activation signal supplying the power necessary for operation of the transponder, while the arrows in fine lines indicate a communication with coded signals.

A variant for the operation of the identification device 2 described in FIG. 1 shall be described below on the basis of FIG. 2. In this variant, the identification system according to the first generation, to which reader 4 is linked, operates in the following manner: reader 4 sends an interrogation or activation signal and all the transponders linked to this system and present within the interrogation or activation field of reader 4 respond by sending an identification code repetitively at variable and random time intervals (the term random is understood to equally mean a pseudo-random or virtually random generation of time intervals, given that the generation means can retain some determinism). The system according to the second generation, to which reader 6 is linked, operates in a similar manner using two different frequencies. In this second system, reader 6 sends an interrogation or activation signal at the first, lower frequency, which activates the transponder 2. In response to this activation, the transponder sends a response signal at the second, higher frequency repetitively and at variable and random time intervals. Thus, the two systems concerned in the variant described here operate on the basis of an automatic response following an activation of the transponder that communicates its identification code once activated. Therefore, the two systems operate according to an anti-collision protocol allowing detection of several grouped transponders present in the interrogation field of the reader, this protocol being based on the generation of random, relatively long intervals between the response signals sent repetitively.

FIG. 2 shows the two response signals emitted by a first transponder A and by a second transponder B located in the interrogation field of one or other of the two readers 4 and 6. The electronic logic circuit 10 of the transponder 2 is configured in order to send the first response signal at low frequency and the second response signal at high frequency in turn. In the variant described here, the same anti-collision protocol is provided for both response signals. Thus, the random time interval of variable length between two response signals at high frequency also corresponds to the time interval between two response signals at low frequency respectively sent following the above-mentioned two response signals at high frequency. As shown in FIG. 2, the response signals at high frequency 52A for transponder A and 52B for transponder B are emitted for a limited period at variable time interval Tn and Tj respectively. After each response signal at high frequency 52A, 52B a response signal at low frequency 50A and 50B respectively is emitted. A fixed period TF is provided between the end of emission of the response signal at high frequency and the start of emission of the response signal at low frequency. It is noted that this fixed period can be relatively short, or even virtually zero.

Since the two response signals are sent in alternation, the time interval between the start of emission of two successive response signals at high frequency or low frequency is higher than or equal to a minimum period T0. This is not a necessary condition for all modes of operation of an anti-collision protocol, but relates to the variant described here or the two response signals are sent in turn and in succession, i.e. without the transmission of the two response signals being at least partially simultaneous.

It is noted that the periods separating the transmission of the signals at low frequency are favourable to enable the transponder 2 to receive sufficient power from the interrogation signal via antenna 14 which, in the exemplary embodiment described in FIG. 1, also serves for transmission of the response signal at low frequency.

In the case represented in FIG. 2, the first signals sent at high frequency and also the first signals sent at low frequency by the two transponders A and B are superposed and therefore generate collisions. Conversely, the second response signals at high frequency are not superposed so that identification of transponders A and B is performed by a double-frequency reader 6. However, as regards the transmission of the second response signals at low frequency, a certain portion remains superposed. Two cases can be envisaged here. In a first case where the identification code is sent once in each response signal at low frequency, there would be a collision with these second signals at low frequency. In a second case where each response signal 50A and 50B respectively includes the repeated transmission of the identification code, e.g. three times, transponders A and B can be identified by a reader 4 despite the partial superposition of response signals 50A and 50B. In both cases, readers 4 and 6 could individually identify transponders A and B during transmission of the third response signals at high frequency and the third response signals at low frequency.

The first response signal and the second response signal each include an identification code of the transponder. In one variant, the contents of these two response signals is identical.

Although the variant described by means of FIG. 2 is advantageous and preferred, other variants for the control of responses at low frequency and high frequency can be anticipated by the skilled person. It can thus be envisaged to send the signal at low frequency repetitively at regular time intervals or even virtually continuously. In such a case, the transmission of the response signal at high frequency can be done in a similar manner to the variant described in FIG. 2, i.e. according to an anti-collision protocol with variable and random time intervals. In another variant, it can be provided that the response signal at low frequency is set according to its own anti-collision protocol, i.e. with its own random distribution for the time intervals separating the transmission of these response signals. Then, obviously, each response signal can contain an identification code and possibly other information. As already mentioned, the identification code can be transmitted a single time in each response signal or several times, e.g. three times.

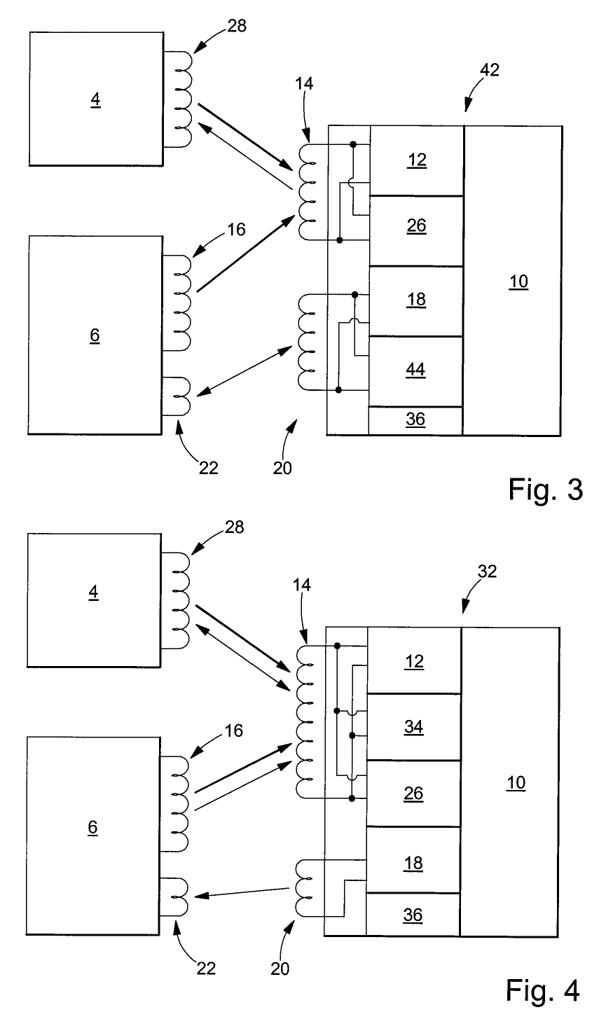

A second exemplary embodiment of an identification device or transponder 42 according to the invention shall be described on the basis of FIG. 3. The references already described above will not be described again in detail here. This second exemplary embodiment differs from the first exemplary embodiment essentially in that it additionally comprises receiving means 44 for commands or data linked to the antenna 20 by reception of a signal at the second frequency, in particular at high frequency. Moreover, the identification device 42 includes an EEPROM memory 36. The receiving means 44 of signals at the second frequency conventionally comprise a demodulator that enables coded data in the signal received by a reader 6 via its antenna 22 tuned to the second frequency to be decoded. This exemplary embodiment thus allows the transponder 42 to receive data from the reader and in particular to be able to write certain data in its memory 36. This configuration also allows an anti-collision protocol to be controlled, in which the reader 6 sends certain commands to control this protocol.

FIG. 4 schematically shows a third exemplary embodiment of an identification device or transponder 32. The references already described above will not be described again in detail here. This third exemplary embodiment differs essentially from the first exemplary embodiment described in that it additionally comprises means 34 for conventionally receiving coded electromagnetic signals at the first frequency via the antenna 14. These receiving means 34 conventionally comprise a demodulator enabling the extraction of data contained in the interrogation signal at the first frequency also serving as power supply of the transponder.

In the third exemplary embodiment of FIG. 4, there is thus a bidirectional communication at the first frequency and a unidirectional communication at the second frequency of the transponder 32 in the direction of the reader 6. As in the second exemplary embodiment, the transponder 32 can receive data and/or commands from a reader, but in this case the data sent from the reader to the transponder are sent at the first frequency. It is thus possible to write data into the memory 36 of the transponder 32.

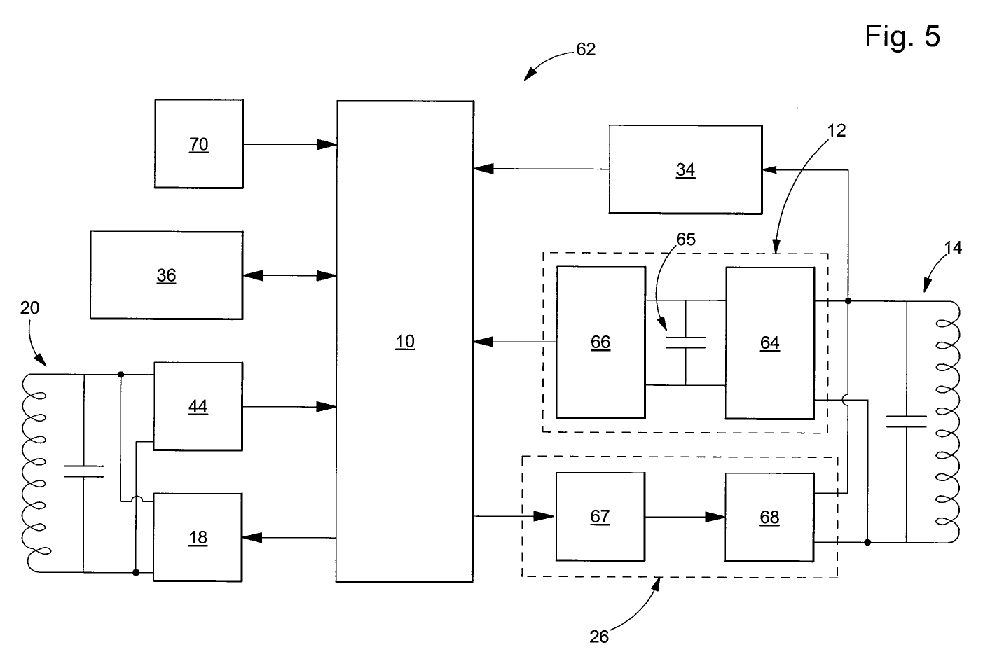

A fourth exemplary embodiment is shown in FIG. 5. In this last exemplary embodiment, a bidirectional communication between a reader and a transponder is provided at the first frequency and also at the second frequency.

Thus, it differs from the third exemplary embodiment in that it additionally comprises means for receiving coded electromagnetic signals sent at approximately said second frequency.

The identification device or transponder 62 comprises an antenna 14 tuned to a first frequency. It comprises a logic circuit 10 run by a signal supplied by the oscillator 70. The trigger circuit 12 is formed by a rectifier 64, which loads a supply capacitor 65. The control of the supply voltage and activation of the transponder are assured by the control unit 66, which sends an activation signal to the logic circuit 10 when the available supply voltage is sufficient to operate the transponder. The transponder then includes a demodulation circuit 34 for coded signals capable of being received by the antenna 14 as well as a modulation circuit 26 according to the invention to transmit a response signal to the reader via antenna 14 by modulating the carrier wave of the interrogation or activation signal received by this antenna 14. The circuit 26 is formed by a low frequency data encoder 67 and a modulator 68 downline. The circuit 10 is linked to an EEPROM memory 36.

The transponder 62 also includes a circuit 18 for emitting response signals at a second, higher frequency via the antenna 20.

Finally, this transponder additionally comprises a demodulation circuit 44 for coded signals capable of being received by antenna 20 at approximately said second frequency.

1. An electronic identification device or transponder comprising:
a trigger circuit linked to receiving means of an interrogation signal sent at a first frequency by a reader, this trigger circuit being configured to convert said received interrogation signal into electric power supply of the identification device or transponder;
first electronic response means linked to means for emitting a first response signal at a second frequency higher than said first frequency;
wherein it additionally comprises second electronic response means linked to means for emitting a second response signal modulating said interrogation signal.

2. The identification device or transponder according to claim 1, wherein it additionally comprises first receiving means for coded electromagnetic signals sent at said first frequency.

3. The identification device or transponder according to claim 1, wherein it additionally comprises second receiving means for coded electromagnetic signals sent at approximately said second frequency.

4. The identification device or transponder according to claim 1, wherein it is configured to supply at least one identification code after being activated by the receipt of said interrogation signal, by emitting in turn said first response signal and said second response signal, which each include said identification code.

5. The identification device or transponder according to claim 4, wherein at least said second signal is sent periodically at variable, and preferably random, time intervals.

6. The identification device or transponder according to claim 5, wherein said first signal is sent subsequent to said second signal after a fixed, and preferably relatively short period.

7. The identification device or transponder according to claim 2, wherein it additionally comprises second receiving means for coded electromagnetic signals sent at approximately said second frequency.
